(19) United States
(12) Patent Application Publication
(10) Pub. No.: US 2015/0089264 A1
(43) Pub. Date: Mar. 26, 2015

(54) PROCESSING APPARATUS AND PROCESSING METHOD

(71) Applicant: KABUSHIKI KAISHA TOSHIBA, TOKYO (JP)

(72) Inventors: Hiroshi NISHIMOTO, Kawasaki (JP); Yuichiro OYAMA, Tokyo (JP); Takeshi ISHIHARA, Yokohama (JP)

(21) Appl. No.: 14/487,503

(22) Filed: Sep. 16, 2014

(30) Foreign Application Priority Data
Sep. 20, 2013 (JP) 2013-196020

(51) Int. Cl. G06F 1/32

(52) U.S. Cl. CPC G06F 1/3268
USPC 713/323

(57) ABSTRACT

There is provided a processing apparatus, including: first and second processors; a first storage which data read or data write is done by one or more fixed-size blocks, data in each block having a sequential address; and a controller to control operation of at least one of the first and the second processors. One of the processors writes, to the first storage, first to N-th data pieces so that an ending address of an X-th data piece and a starting address of an X+1-th data piece are sequential. The controller sets the other processor in a low power consumption mode during at least a part of a period in which the one processor performs writing to the storage, and after that, the controller sets the other processor in a normal or active operating mode in which the other processor is capable of reading the data pieces from the first storage.

### CROSS-REFERENCE TO RELATED APPLICATIONS

This application is based upon and claims the benefit of priority from Japanese Patent Application No. 2013-196020, filed Sep. 20, 2013; the entire contents of which are incorporated herein by reference.

### FIELD

Embodiments described herein relate to a processing apparatus and a processing method.

### BACKGROUND

Constant internet access is improving the convenience of mobile devices, such as laptop computers and smartphones. Constant internet access increases power consumption in terminals, which poses a problem of draining batteries faster. Accordingly, power-saving technique is demanded in network processing performed in mobile devices.

Conventionally, as a method for reducing power consumption in network devices, there has been known a method in which a wireless base station or a server adjusts the timing of transmitting data to a mobile device and/or buffers the data before transmitting to the mobile devices. This approach requires both the server and mobile device to have a large memory capacity.

However, since mobile devices are usually small and only have small area to mount memory modules, mobile devices have only a limited amount of memory. Thus it is difficult to apply the aforementioned approach. Therefore, a different technique is necessary to enhance power consumption efficiency.

### BRIEF DESCRIPTION OF THE DRAWINGS

FIG. 1 is a block diagram illustrating a communication apparatus according to a first embodiment;

FIG. 2 illustrates one example of an operation flow of the first embodiment;

FIG. 3 illustrates one example of the detailed flow of a process of step S108 in FIG. 2;

FIG. 4A illustrates one example of the content of a data storage illustrated in FIG. 1;

FIG. 4B illustrates another example of the content of the data storage illustrated in FIG. 1;

FIG. 5 is a block diagram illustrating a communication apparatus according to a second embodiment;

FIG. 6 illustrates an operation flow of the communication apparatus in the case of performing a transmission process according to the second embodiment;

FIG. 7 illustrates an operation flow of the communication apparatus in the case of performing a reception process according to the second embodiment;

FIG. 8 is a sequence diagram illustrating operation according to a specific example of the communication apparatus according to the second embodiment;

FIGS. 9(A)-9(C) illustrate the content of a data storage according to a third embodiment; and

FIGS. 10(A) and 10(B) illustrate data pieces being stored in the data storage.

### DETAILED DESCRIPTION

According to one embodiment, there is provided a processing apparatus, including: a first processor; a second processor; first storage which data is written or read by one or more fixed-size blocks, data in each block having a sequential address; and a controller to control operation of at least one of the first processor and the second processor.

One of the first processor and the second processor writes, to the first storage, first to N-th data pieces in order to deliver the first to N-th data pieces to the other processor so that an ending address of an X-th data piece and a starting address of an X+1-th data piece are sequential addresses wherein “N” being an integer of 2 or more and “X” being an integer of 1 or more.

The controller sets the other processor in a low power consumption mode during at least a part of a period in which the one processor performs writing to the first storage, and after completion of the writing to the first storage, the controller sets the other processor in a different operating mode in which the other processor is capable of reading the first to N-th data pieces from the first storage.

Hereinbelow, embodiments of the present invention will be described with reference to the accompanying drawings.

### FIRST EMBODIMENT

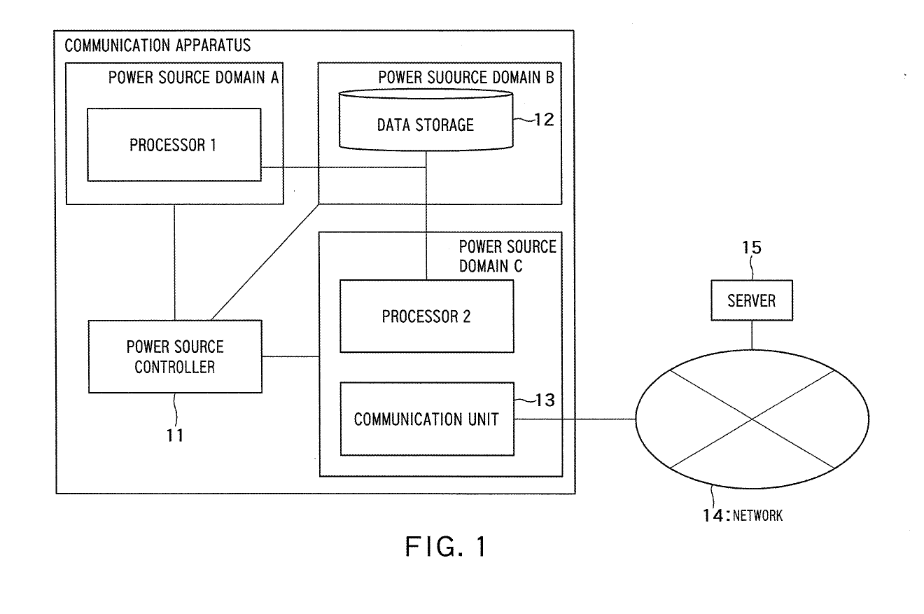

FIG. 1 is a block diagram illustrating a communication apparatus including a processing apparatus according to an embodiment of the present invention.

This communication apparatus can communicate with another communication apparatus, such as a server 15, via a communication network 14. For example, the communication apparatus can download contents such as a web page file from the server 15 or upload contents to the server. This communication apparatus is equipped in, for example, terminals such as mobile terminals, desktop PCs, and notebook PCs.

This communication apparatus includes a processor 1, a data storage 12, a processor 2, a power source controller 11, and a communication unit 13. The processing apparatus of the present embodiment may be defined as an apparatus including the processor 1, the data storage 12, the processor 2, and the power source controller 11, or may further include the communication unit 13.

The power source controller 11 controls power supply in units of power source domains. In the present embodiment, power source domains A to C are present. The power source domain A has the processor 1, the power source domain B has the data storage 12, and the power source domain C has the processor 2 and the communication unit 13. The respective power source domains individually control power supply through the power source controller 11. The respective power source domains may be on the same chip or substrate, or may be on separate chips or substrates.

In one example, the power source domain A may be placed on a mainboard, and the power source domains B and C may be placed on a network interface card (NIC) connected to the mainboard. In one example, the processor 1 may be a CPU (first processor) that executes OS or applications and the like, the processor 2 may be a microcomputer (second processor) which controls execution of an instructed process upon reception of an instruction of the CPU, the communication unit 13 may be a communication interface that performs processing of a MAC layer, a physical layer, and the like, and the data storage 12 may be a memory device. There are various types of memory devices, including volatile memories that permit data read and write in units of bytes such as SRAMs, DRAMs, and MRAMs, and memories which data is written and read by one or more fixed-size blocks, such as a NAND flash. In the present embodiment, it is assumed that the data storage 12 is a NAND flash memory. The data storage is not limited to the NAND flash memory, and may be other memories that read or write in units of blocks.

The processor 1 instructs the processor 2 to execute arbitrary processes, such as an acquisition request and a transmission request of data such as a file. In one example, the processor 1 outputs to the processor 2 an acquisition request of a web page and the like with its URI specified.

The processor 2 operates upon reception of the instruction from the processor 1. If the acquisition request has an URI specified, the data identified by the URI is acquired from the server on the network, and the processor 2 performs operation of writing the acquired data and the like to the data storage 12. Once the instructed process is completed, the processor 2 notifies completion of the process to the processor 1.

The data storage 12 stores execution result data obtained as a result of processing in the processor 2 and data necessary for the processor 1 to instruct the processor 2. The data necessary for instruction may include an acquisition instruction command with an URI specified in the case of instructing acquisition, and may include a transmission instruction command and transmission data to be transmitted in the case of instructing data transmission. The processor 1 may deliver the instruction to the processor 2 via the data storage 12, and may also directly deliver the instruction without using the data storage 12. Both the processor 1 and the processor 2 can read or write data from/to the data storage 12.

When a process completion notification is received from the processor 2, the processor 1 accesses the data storage 12 and reads out the execution result data. In the case where the acquisition request is a request to acquire data from the server, data received from the server and the like are stored in the data storage 12. The processor 1 may write the read execution result data to a nonvolatile memory such as a DRAM not illustrated in the drawing.

The communication unit 13 performs wireless or wired communication with other communication apparatuses connected to the network. Communication counterpart apparatuses may be, for example, servers such as web servers, file servers, and other terminals. The network may be a wired or wireless arbitrary network. The network may be a single network or may be a composite network made up of a plurality of wired or wireless networks.

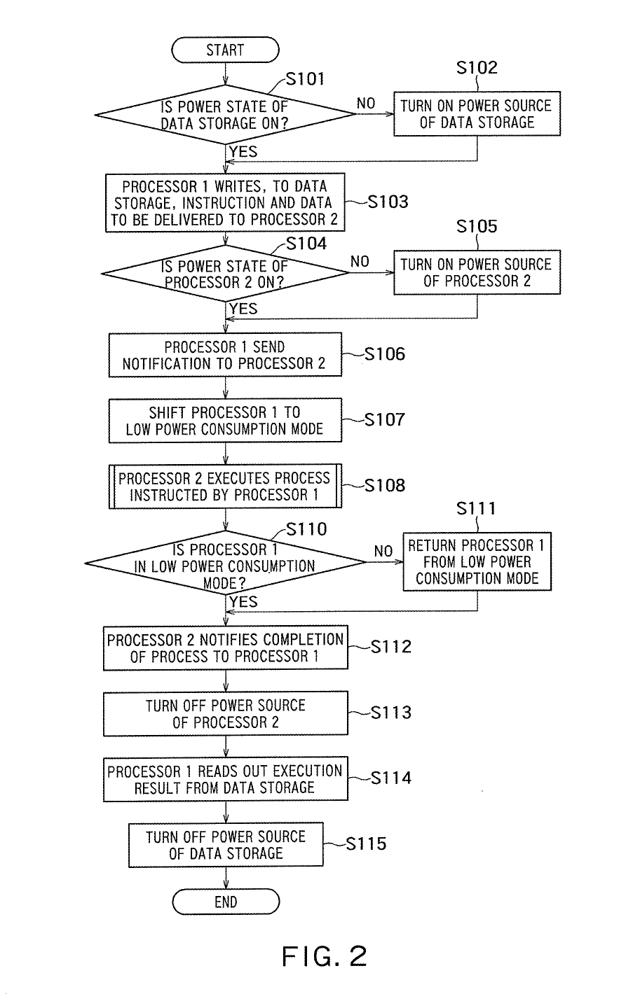

FIG. 2 illustrates one example of an operation flow in the present embodiment.

When the processor 1 instructs the processor 2 to execute a process, the power source controller 11 confirms a power state of the data storage 12 first (S101). If the power source of the data storage 12 is off (OFF), the power source is turned on (ON).

When the processor 1 is notified that the power source of the data storage 12 is in ON state by the power source controller 11, the processor 1 writes to the data storage 12 an instruction for the processor 2 and data to be delivered to the processor 2 as necessary. The instruction may directly be transmitted to the processor 2. When the power source of the processor 2 is OFF, the instruction may be sent after the processor 2 is turned on in subsequent step S105. In the case of writing transmission data and the like to the data storage 12, a structurized data piece (a data which contains a identifier, a data length, and a piece of data) that is one of the characteristics of the present embodiment, as well as a data management table are written as described later.

The power source controller 11 confirms the power state of the processor 2, and if the power source of the processor 2 is OFF, the power source is turned on (S105).

The processor 1 instructs the processor 2 to execute a process (S106). The instruction may be notified through a predetermined region of the data storage 12, or may directly be notified to the processor 2.

When the power source controller 11 receives a report that the processor 1 sent the notification to the processor 2, the power source controller 11 uses this report as a trigger to shift the processor 1 from a operating mode such as normal mode or active mode to a low power consumption mode (S107). Or when the power source controller 11 receives a report that the processor 2 received an instruction notification from the processor 1, the power source controller 11 may use this report as a trigger to shift the processor 1 from the present operating mode to a lower power consumption mode.

Here, the low power consumption mode may be implemented by stopping power supply to the entire circuit of the processor 1, by stopping power supply to a part of the circuit, by reducing an operating frequency, or by compulsorily stopping execution of a specific process. It is also possible to configure so that when a condition, such as the processor 1 having a process that must preferentially be executed, is fulfilled, the processor 1 is not shifted to the low power consumption mode. In the above described example, there are ON/OFF dual mode control in the data storage and the processor 2. However, control may be performed by defining a low power consumption mode and a normal operating mode as in the processor 1 instead of the ON/OFF control modes. In the case of ON/OFF control modes, the ON state corresponds to a operating mode such as normal mode or active mode, and the OFF state corresponds to a low power consumption mode.

The processor 2 executes a process instructed by the processor 1 while the processor 1 is in the low power consumption mode (S108). The details of this step are described later. In the example of this flow, the processor 1 is in the low power consumption mode during the entire period in which the processor 2 is performing the instructed process. However, the processor 1 may be in the low power consumption mode only during at least a part of the period.

Once execution of the process in the processor 2 is completed, the power source controller 11 confirms the power state of the processor 1 (S110). If the processor 1 is in the low power consumption mode, the processor 1 is returned to the normal operating mode (S111).

When the processor 2 is notified from the power source controller 11 that the processor 1 is in the normal operating mode, the processor 2 sends a process completion notification to the processor 1 (S112).

When the power source controller 11 receives a report that the processor 1 received the process completion notification from the processor 2, the power source controller 11 turns off the power source of the processor 2 (S113). When the power source controller 11 receives a report that the processor 2 sent the process completion notification to the processor 1, the power source controller 11 may use this report as a trigger to turn off the power source of the processor 2.

When the processor 1 receives the process completion notification from the processor 2, the processor 1 reads out the execution result data from the data storage 12 (S114). If the content of the instruction sent to the processor 2 is a data acquisition request, the data acquired from the server and the like is read out from the data storage 12 as the execution result data. If the instruction is a transmission request, the result indicating success or failure of transmission is read out from the data storage 12. It is possible to configure so that the processor 2 directly notifies the result indicating success or failure of transmission to the processor 1.

Then, the power source controller 11 receives from the processor 1 a notification of completion of reading from the data storage 12. By using the notification as a trigger, the power source controller 11 turns off the power source of the data storage 12 (S115).

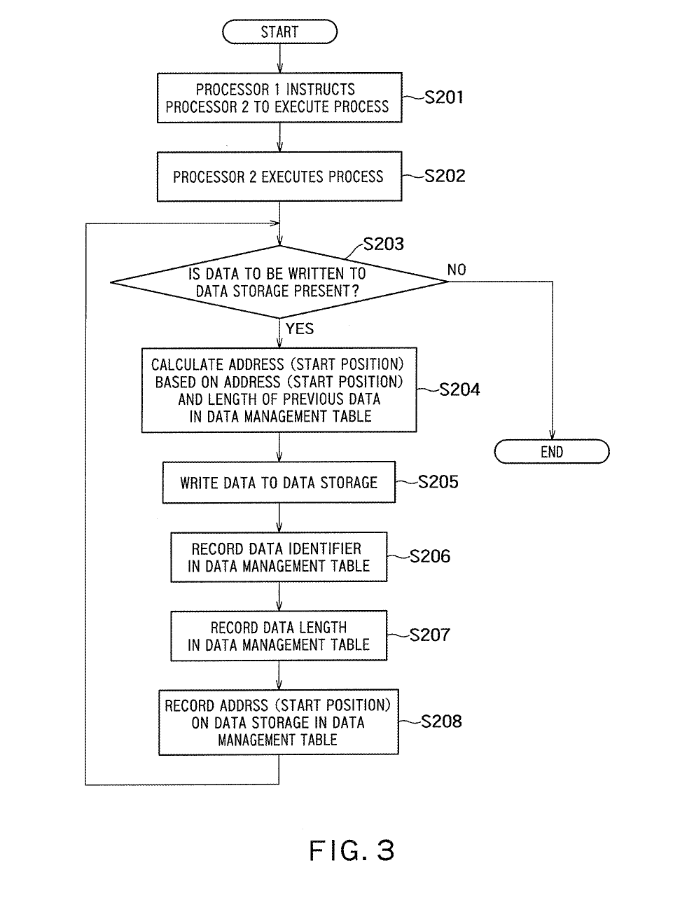

FIG. 3 illustrates one example of the detailed flow of the process in step S108 in FIG. 2. The processor 1 instructs the processor 2 to execute a process in which the same operation is repeated, such as reception of a plurality of files and transmission of a plurality of files (S201). Here, a case is described in which the processor 1 instructs the processor 2 to acquire a plurality of files from the server on the network.

In response to the request from the processor 1, the processor 2 sequentially acquires data which serves as a response from the server (S202), and writes the acquired data and the like to the data storage 12 (S203, S204, S205). In step S203, at the first write (first processing of a loop), a head address of a block determined by an arbitrary method is determined as a write start address. The data serving as a response is a response data itself including information such as a header. The file requested to be acquired is also included therein. During acquisition of the data and the like, the processor 2 may analyze the acquired data to determine a data length and a data type, and may also acquire related data as well. In data write, there are written structurized data pieces each formed by adding management information to the head of each data piece, the management information including either a data identifier uniquely identifying a data piece or length information of the data piece (data length), or including both the data identifier and the data length information.

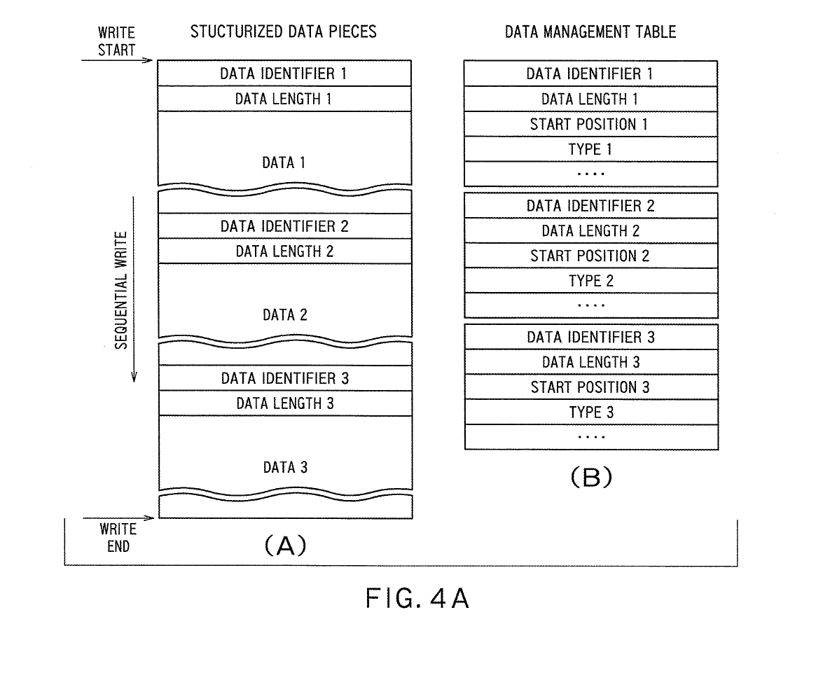

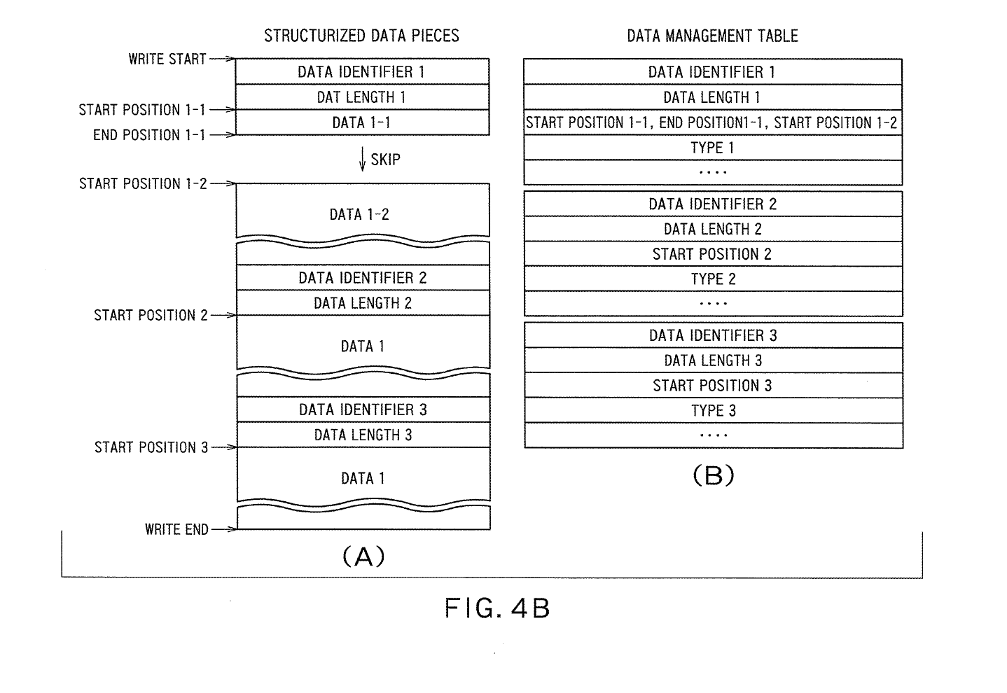

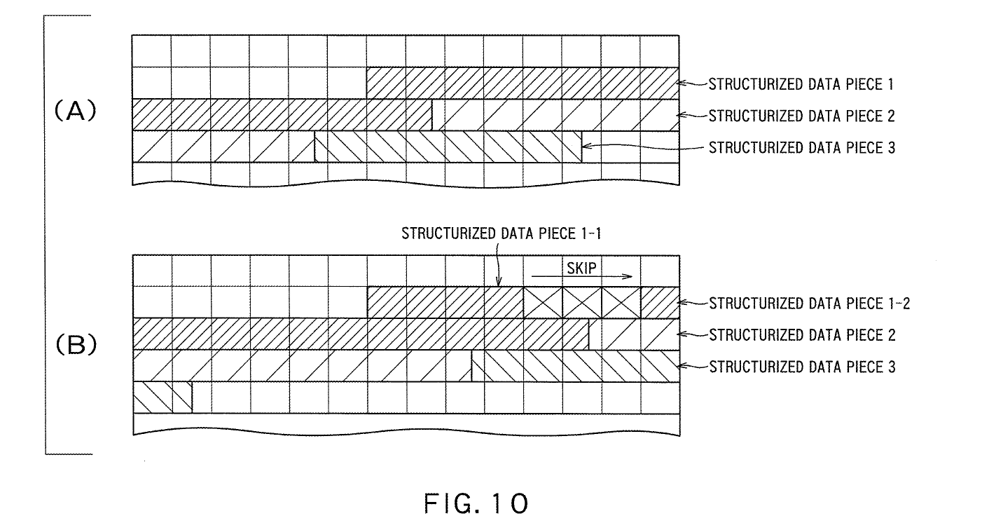

FIG. 4A (A) illustrates an example of the structurized data pieces (data identifier+data length+data piece). For example, when a data piece 1 is acquired, a structurized data piece 1, formed by coupling a data identifier 1 of the data piece 1, a data length 1, and the data piece 1, is written to sequential addresses of the data storage 12. FIG. 10(A) illustrates an example in which the structurized data piece 1 is stored in the data storage 12. Each rectangle divided with a solid line schematically expresses a block. The data in each block have a sequential address. A direction from the left side to the right side along the drawing is an ascending order direction of the addresses. The addresses are larger toward lower rows. The structurized data piece 1 is written to sequential addresses, starting from the head of a seventh block in a second row and ending at the middle of one block. Information of a starting address of the block to which a first write access is made (here, a head address of the structurized data piece 1) may be stored in a specified region of the data storage 12 or inside the processor 2 as an index. The information may be used at the time of reading.

Here, the data identifier may be a unique ID which can uniquely be derived from an acquisition request (command) with an URI and the like being specified, or may be a command or an URI itself. If the length of the ID is set shorter, the memory size can advantageously be reduced. The data length may be acquired from header information of the data received from the server, or may be acquired by analyzing the length of the data. If the acquisition request is an HTTP request, a response is an HTTP response. The entire HTTP response is handled as a data piece and is stored in the data storage 12 as a structurized data piece which also includes a data identifier and a data length.

The processor 2 writes the data to the data storage 12, and also makes a write access to the data management table illustrated in FIG. 4A (B) (S206 to S208). Although the data management table is also stored in the data storage 12, it is possible to configure so that the processor 2 internally holds the data management table. Information of a storage location of the data management table in the data storage 12 is held in a specified region of the data storage 12, so that the data management table may be acquired when the processor 1 or the processor 2 accesses the specified region later. The data management table holds, for each data piece, attribute information such as a data identifier, a data length, a data start position, and a data type. The processor 2 writes to the data management table the attribute information of the acquired data, such as a data identifier, a data length, a data write start position (write start address) in the data storage to which the acquired data was written, and a data type (such as a text type, an image type, etc.). For example, a start position 1 of FIG. 4A (B) is a starting address of the data piece 1 in FIG. 4A (A).

When any piece of data to be written to the data storage 12 is still present, a next data write start position in the data storage 12 is calculated with reference to the data management table based on the information of a start position of previously written data and its data length, and further based on information of each fixed-length size of the data identifier and the data length (S203, S204). A write start position of a structurized data piece to be written next is arranged to be an address sequential with an end position (ending address) of the previously written data piece. If the ending address of the previously written data piece is an address in the middle of a block, a next structurized data piece is written to an address next to the former address in the same block. In the example illustrated in FIG. 4A (A) and FIG. 10(A), the structurized data piece 1 is followed by a structurized data piece 2 and a structurized data piece 3 to be written. The structurized data pieces are written so that the ending address of the structurized data piece 1 and the starting address of the structurized data piece 2 are sequential (sequential in one block, or the ending address of one block aligns with the starting address of the next block). Similarly, the structurized data pieces are written so that the ending address of the structurized data piece 2 and the starting address of the structurized data piece 3 are sequential (sequential in one block, or the ending address of one block aligns with the starting address of the next block). As illustrated in FIG. 4A(B), each attribute information of the structurized data piece 2 and the structurized data piece 3 is also written to the data management table. Thus, not only one structurized data piece but also a plurality of structurized data pieces are written so that their addresses are sequential.

However, a block that stores data of another application or the like may appear in the middle of writing. In that case, the data in that block may be deleted and then new data may be written thereto if that is possible. However, it is sometimes not permitted to delete the data. In that case, since it is impossible to write data to the blocks of sequential addresses, the pertinent blocks may be skipped and data write may be restarted from the head of a block at a distant position. The data structure in this case is illustrated in FIG. 4B (A) and FIG. 10(B). In FIG. 10(B), blocks marked with “x” represent unwritable blocks.

When the continuity of blocks is interrupted, the ending address information of the interrupted block and the starting address information of a newly started block may be held as a pointer. If the “start position” in the data management table is modified to “start position, end position, and start position” by adding the end position (ending address) and the start position (starting address), data read can be performed while the continuity of data is maintained. For example, as illustrated in FIG. 4B (A), when a write access to sequential blocks becomes impossible in the middle of writing the data piece 1, information of an end position 1-1 of an interrupted block and a start position 1-2 of a block where write is restarted may be stored. This information may be notified to the processor 1 like the first write start position of the structurized data piece. In addition to the start position 1 (1-1), the end position 1-1 and the start position 1-2 are also added to the data management table (FIG. 4B (B)). Similarly, in the case where write to sequential addresses becomes impossible in the middle of writing a data identifier and/or a data length (when the continuity of blocks is interrupted), data read can successfully be performed by additionally storing the information of the end position and the start position. The process to be performed when the continuity of the blocks (continuity of addresses) is interrupted as described herein is merely an example. Any method can be used as long as the continuity of the blocks which are distant from each other can be expressed.

The method for write access as described above is referred to as sequential write. Since the sequential write makes it possible to successively read data in blocks (to perform sequential read) at the time of data read from the data storage, deterioration in operation speed can be suppressed while low power consumption can be achieved. When read from the data storage is performed by DMA transfer, the number of read instructions can be reduced while low power consumption can be achieved since the start position and the read size are specified in the DMA transfer. Since data is efficiently stored in each block, the number of read or written blocks can be reduced, which leads to achievement of low power consumption.

A description is further given of efficient storing of data in respective blocks. One set of response data may normally be divided into a plurality of packets and carried, since the allowable data size length of a packet is limited. When the processor 2 has a buffer of a sufficient size, the data carried by each packet may be coupled into one data piece and be written as one structurized data piece. In one case, one packet data written at a time, and in another case, whenever some pieces of packet data are accumulated, the accumulated data pieces may collectively be written. In the latter two cases, a plurality of data writes are performed. Accordingly, unless special processing is performed, respective data pieces are written to the blocks in an uneven pattern, and the respective blocks may have wasted regions where data is not written thereto. A read access to such a region in block units is inefficient. Accordingly, in the present embodiment, since data is written to sequential addresses as much as possible, divided data pieces to be written also become sequential in the same block. This makes it possible to achieve efficient write and read. Individual structurized data pieces are also arranged so that the ending address of a previously written structurized data piece and the starting address of a structurized data piece to be written next become as sequential as possible as mentioned above. Even when write of one structurized data piece is completed in the middle of one block, the following structurized data piece is set to be written to the next address in the same block.

Once all the data pieces requested by the processor 1 are written, the process of this flow is ended. In step S112 of FIG. 2, the processor 2 notifies completion of writing to the processor 1.

Then, in step S114 of FIG. 2, the processor 1 reads out data from the data storage 12. A description is given of an example of the operation performed when the data pieces 1, 2, and 3 are read out in this order. The processor 1 identifies a start position 1 of the data piece 1 from the data management table in the data storage 12, and reads out length data of the data length 1 from the start position 1, by which the data piece 1 is acquired. A data identifier deriving method is shared in advance by the processor 2 and the processor 1.

Although the case of acquiring data by using the data management table has been described, the data may directly be read out from the structurized data pieces without using the data management table. In that case, a head address of the structurized data piece (a head address of the data of the data identifier 1 in the illustrated example) is notified to the processor 1. The notification may be performed through a specified region of the data storage 12, or the processor 1 may directly be notified. The processor 1 reads out the structurized data piece, starting from the head of the data piece. This makes it possible to identify and acquire each of the data pieces 1, 2, and 3 based on the data identifier and the data length of each data pieces.

Although the example of acquiring a plurality of files from the server has been presented in the above illustration of FIG. 2, the same operation applies when a plurality of files are transmitted. In this case, write to the data storage 12 is mainly performed by the processor 1. The processor 2 reads out and transmits data pieces included in the structurized data pieces in the data storage 12.

In the present embodiment, the structurized data pieces are written to the data storage 12. However, in a modification, only the data pieces may be stored in the data storage 12 and a necessary data piece may be identified and read out from the data storage 12 by using the data management table.

As described in the foregoing, according to the present embodiment, it becomes possible to deliver data and the like through a nonvolatile storage such as a NAND, while preventing slowdown in operation speed and enhancing power saving efficiency.

For example, consider the case where the processor 1 is made to sleep for low power consumption, and the processor 2 acquires data from the server and writes the data to the storage such as a NAND, activating the processor 1 and performing collective delivery of the data. In such a case, if the data is written to the storage such as a NAND in an uneven pattern, an action of excessively reading a large number of blocks is generated, which causes slowed speed and large power consumption. Contrary to this, in the present embodiment, each data piece received from the server is written to the sequential addresses. Therefore, when the processor 1 reads out the data pieces, the data pieces can be read out at high speed and low power consumption.

### SECOND EMBODIMENT

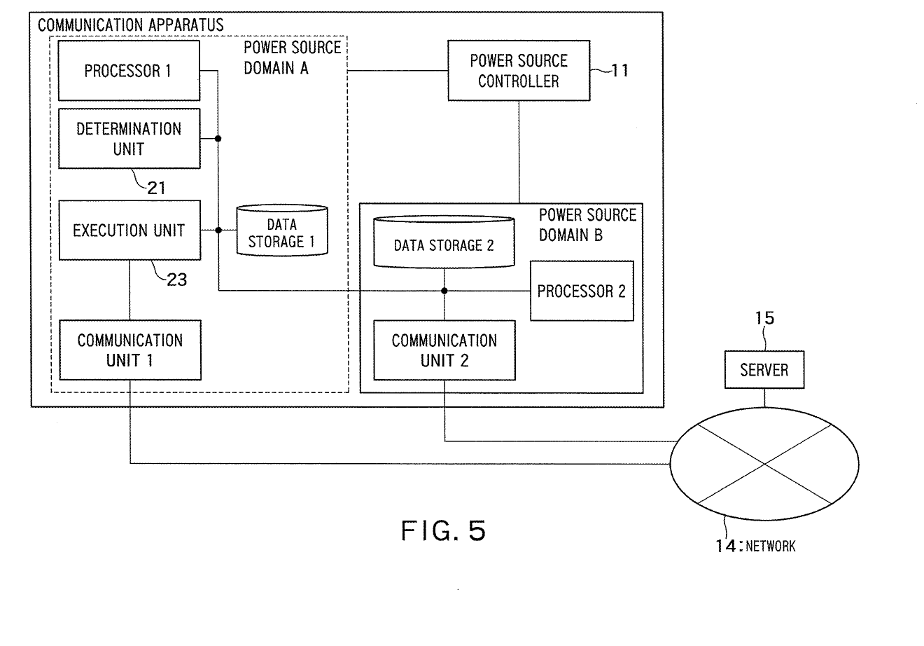

FIG. 5 is a block diagram illustrating a communication apparatus according to a second embodiment. The communication apparatus of the present embodiment includes a processor 1, a determination unit 21, a data storage 1, an execution unit 23, a communication unit 1, a processor 2, a data storage 2, a communication unit 2, and a power source controller 11. The functions of the processor 1, the determination unit 21, and the execution unit 23 may be realized by software executed by an identical processor.

This communication apparatus has two power source domains A and B where the respective power sources can be controlled independently of each other. The respective power source domains may be on an identical SOC, or may be configured on separate substrates.

The power source domain A has the processor 1, the determination unit 21, the data storage 1, the execution unit 23, and the communication unit 1.

The power source domain B has the processor 2, the data storage 2, and the communication unit 2.

The processor 1 and the processor 2 are similar to those in FIG. 1. The data storage 2 is similar to the data storage 12 of FIG. 1. In one example, the data storage 2 is a NAND flash memory. The power source controller 11 controls power supply to the power source domains A and B.

The data storage 1 is a storage having excellent random access performance as compared with the data storage 2. The data storage 1 is a high-speed memory device. In one example, the data storage 1 may be an SRAM, a DRAM, or an MRAM. Having excellent random access performance indicates that data read or write can be performed with granularity as fine as in byte units as compared with the data storage 2 which performs read or write in relatively large units of blocks.

The communication units 1 and 2 are communication interfaces which perform processing of a MAC layer and a physical layer like the communication unit 13 of FIG. 1. The communication units 1 and 2 performs wireless or wired communication with other communication apparatuses connected to the network. Although the communication apparatus is configured to include two communication units, the apparatus may be configured to include only one communication unit, which is shared by the processors 1 and 2. In this case, one communication unit may be placed in an independent power source domain C, or may be placed in the power source domain A or B.

The determination unit 21 determines whether or not it is adequate to use the processor 2 as a proxy of the processor 1 in execution of processes. The determination unit 21 determines the adequacy based on the content of a request for the processor 1, the type of communications protocol used in execution of the process, and the like. For example, in the case of an HTTP GET request and the like, prefetching can be used. Therefore, it is determined to be adequate to use the processor 2 as a proxy. In the case of an HTTP HEAD request and the like, an effect of using the processor 2 as a proxy is low since prefetching is unnecessary, and therefore use of the processor 2 as a proxy is determined to be inadequate.

Here, the prefetching refers to a function of acquiring in advance an embedded object (such as an image file, a script file, and a style sheet) referred from the HTML file originally requested. For example, consider the case where a web page is requested by using the HTTP. The web page is made up of an HTML file which provides structure and character information of the web page, a style sheet which provides information on design of the page, a script file, an image file, and the like. The web page is correctly displayed when all these files are acquired. Generally, HTML file is acquired and the content thereof is analyzed at first, then it is recognized that the style sheet, the script file, and the image file are referred. Because of this reason, a large number of acquisition requests are sequentially generated, and communication efficiency is deteriorated. Accordingly, when the processor 2 receives an HTML file from the server for the first time, the file is analyzed, and other referred files are identified and pre-fetched in sequence.

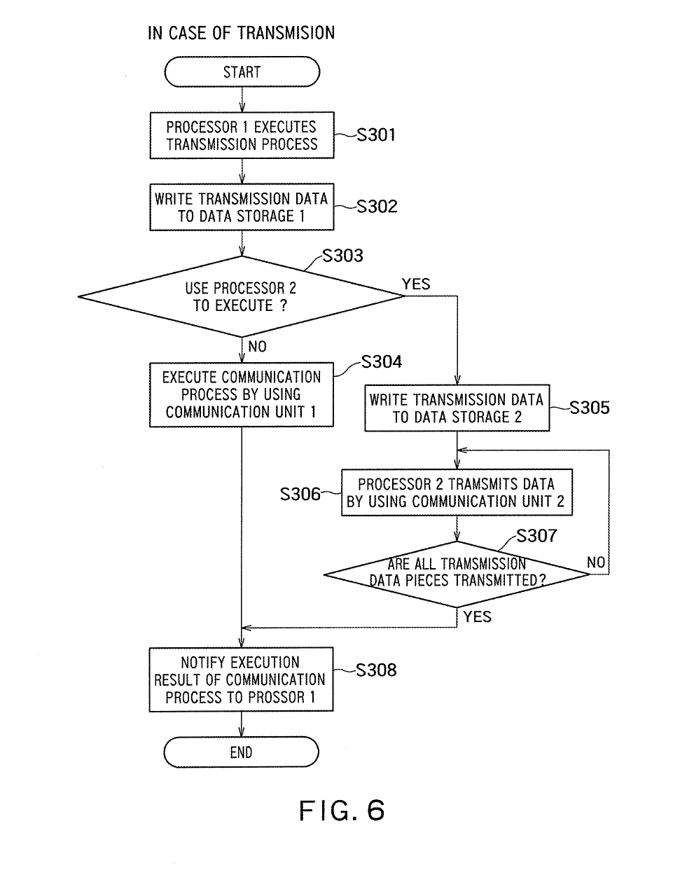

FIG. 6 illustrates an operation flow of the communication apparatus in the case of performing a transmission process according to the second embodiment.

When the processor 1 starts execution of a transmission process (S301), the processor 1 writes transmission data to the data storage 1 (such as a DRAM) (S302). The determination unit 21 determines whether or not to use the processor 2 as a proxy to execute the transmission process. If the processor 2 is not used as a proxy, the execution unit 23 reads out the transmission data from the data storage 1 and executes the transmission process by using the communication unit 1 (S304). Once the process is completed, the execution unit 23 notifies an execution result indicating completion of the process to the processor 1. Since the processor 2 is not used in the above process, the power source controller 11 may turn off the power source domain B or set the power source domain B in the low power consumption mode.

If the determination unit 21 determines to use the processor 2 as a proxy to execute the transmission process, the power source domain B is turned on with the power source controller 11 if the power source domain B is off. Then, the execution unit 1 reads out the transmission data from the data storage 1, and writes the data to the data storage 2 (S305). Data write is implemented by writing a structurized data piece and a data management table as described in the first embodiment. Sequential write is used to write the structurized data piece. After write is completed, the power source domain A may be turned off or be shifted to the low power consumption mode.

The processor 2 reads out the data from the data storage 2, and transmits the data by using the communication unit 2. When the structurized data pieces as in FIG. 4A (A) are stored, repeated data read from the data storage 2 and data transmission are performed until transmission of all the data pieces 1, 2 and 3 are completed (S306, S307). Since sequential write is performed in the data storage 1, the data pieces can efficiently be read out.

Once transmission of all the data pieces is completed, the power source domain A is shifted to the normal operating mode with the power source controller 11 as necessary. The processor 2 notifies an execution result indicating completion of the process to the processor 1 (S308).

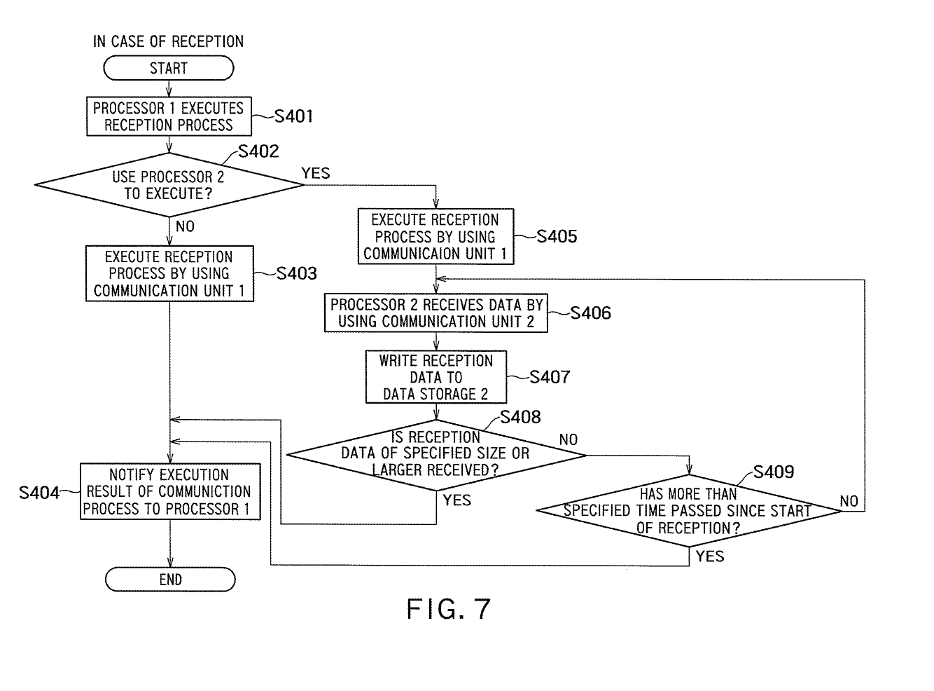

FIG. 7 illustrates an operation flow of the communication apparatus in the case of performing a reception process according to the second embodiment.

When the processor 1 starts execution of a reception process (S401), the determination unit 21 determines whether or not to use the processor 2 as a proxy to execute the reception process (S402). If the processor 2 is not used as a proxy, the execution unit 23 executes the reception process by using the communication unit 1 (S403). The execution unit 23 writes the received data to the data storage 1. Once the process is completed, the execution unit 23 notifies an execution result indicating completion of the process to the processor 1 (S404). Since the processor 2 is not used in the above process, the power source controller 11 may turn off the power source domain B or set the power source domain B in the low power consumption mode.

If the determination unit 21 determines to use the processor 2 as a proxy to execute the reception process, the power source domain B is turned on with the power source controller 11 if the power source domain B is off. Then, the execution unit 1 instructs the processor 2 to execute the reception process (S405). The processor 2 performs data reception from the server and the like by using the communication unit 2 (S406). The processor 2 uses the sequential write described in the first embodiment to write a structurized data piece including a received data piece to the data storage 2 (S407). The processor 2 also makes a write access to the data management table.

If there are pieces of data to be pre-fetched, all the data pieces are also acquired. When prefetching is performed, a data identifier is generated based on a prefetching request (command) and the like, and a structurized data piece including the data piece acquired by prefetching is written to the data storage 2. Attribute information is also written to the data management table.

When all the instructed data pieces are received (for example, when the instructed data has a specified size, and the data of the specified size or more is received) (YES in S408), the processor 2 shifts the power source domain A to the normal operating mode with the power source controller 11 as necessary, and notifies an execution result indicating completion of the process to the processor 1 (S404).

Then, the execution unit 23, the processor 1, or the processor 2 copies or moves the structurized data piece from the data storage 2 to the data storage 1. At this time, a list that associates with addresses of the data storage 1 (such as a DRAM) that stores the structurized data piece may be generated and be used in subsequent read accesses. The data management table may also be copied or moved. Since the sequential write to the data storage 2 is performed, efficient read (sequential read) of the structurized data pieces can be achieved. Since a randomly accessible memory such as a DRAM is assumed as the data storage 1, data may be written to the data storage 1 by arbitrary methods. In the case where data reception is not yet completed but more than a specified time has passed since the start of reception (YES in S409), the process is time out and is ended. The power source domain A may be shifted to the normal operating mode with the power source controller 11 as necessary, and then the process execution result may be notified to the processor 1 (S404). The specified time may be predetermined or the processor 1 may notify the time to the processor 2.

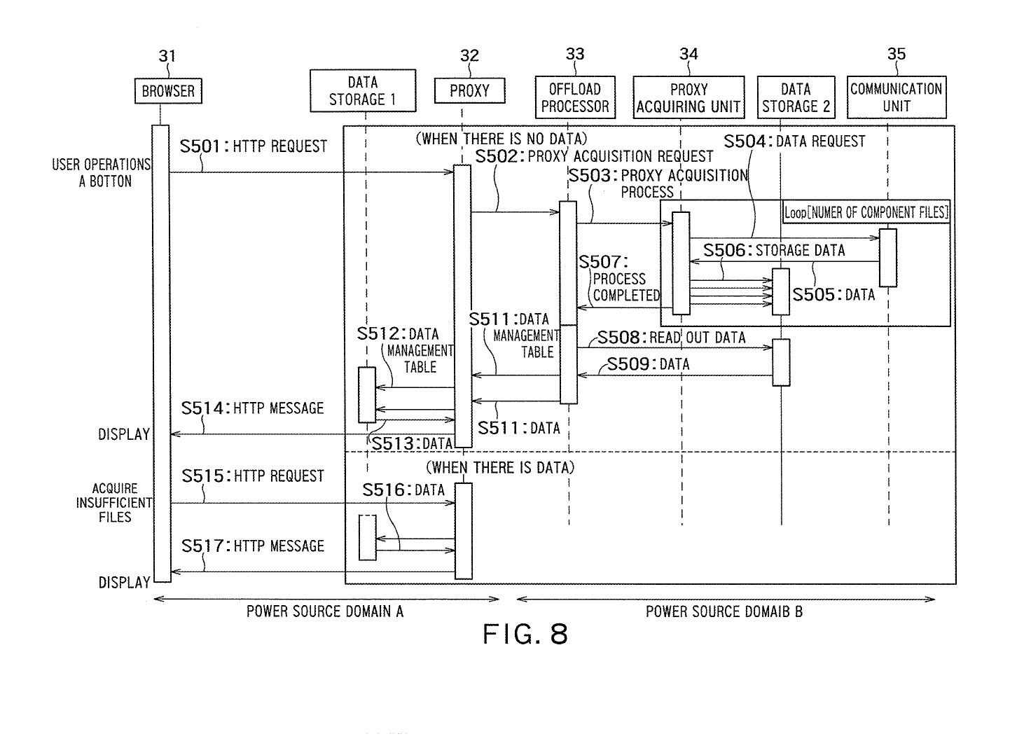

FIG. 8 is a sequence diagram illustrating operation according to a specific example of the communication apparatus according to the second embodiment.

Illustrated is the operation in the case where the processor 1 illustrated in FIG. 5 corresponds to a browser 31, the determination unit 21 and the execution unit 23 correspond to a proxy 32, the processor 2 corresponds to an offload processor 33 and a proxy acquiring unit 34, and the communication unit 2 corresponds to a communication unit 35.

When a user operates a button, an HTTP request is issued from the browser 31 (S501). Since the data corresponding to the HTTP request is not in the data storage 1, the proxy 32 issues a proxy acquisition request to the offload processor 33 (S502). At this time, if the power source domain 2 is OFF, the power source domain 2 is turned on by the power source controller 11. The power source domain A may also be shifted to the low power consumption mode.

The offload processor 33 instructs the proxy acquiring unit 34 to execute a proxy acquisition process (S503). The proxy acquiring unit 34 communicates with an external server by using the communication unit 35, and acquires a data piece (S504, S505). When embedded objects and the like are included in the acquired data piece (file), the proxy acquiring unit 34 performs the aforementioned prefetching to also acquire the embedded objects. The proxy acquiring unit 34 uses the sequential write described in the first embodiment to write a structurized data piece including the received data piece to the data storage 2 (S506). The proxy acquiring unit 34 also makes a write access to the data management table.

Once data acquisition is completed, the proxy acquiring unit 34 notifies completion of the process to the offload processor 33 (S507). At this time, if the power source domain 1 is in the low power consumption mode, the power source domain 1 is shifted to the normal operating mode. The offload processor 33 notifies completion of proxy acquisition to the proxy 32, and the proxy 32 reads out the structurized data piece and the data management table from the data storage 2 via the offload processor 33 (S508, S509, S510, S511). The proxy 32 may also directly read out the data from the data storage 2 without using the offload processor 33. The data management table may be read out from the data storage 2, or the offload processor 33 may deliver the data management table held in an internal buffer of the offload processor 33. The proxy 32 writes the structurized data piece and the data management table which are acquired to the data storage 1. At that time, the power source domain B may be turned off. The proxy 2 then reads out the data corresponding to the HTTP request from the data storage 1, and returns the data to the browser 31 as a response (S514).

When the proxy 32 again receives an HTTP request from the browser 31 (S515) and a requested URI is identical to the URI of the embedded file acquired before, the requested data has already been prefetched and is stored in the data storage 1. Accordingly, the proxy 32 reads out this data from the data storage 1 (S516), and returns the data to the browser as a response (S517).

At the time of data read, structurized data pieces may be searched from the head data to identify a target data piece by using the data identifier or to identify by referring to the data management table. Or a list of addresses of the data storage 1, in which the structurized data pieces are stored at the time of writing to the data storage 1, is generated in advance, and the target data piece may be identified by referring to the list.

### THIRD EMBODIMENT

Since the block diagram of the present embodiment is similar to FIG. 1 used in the first embodiment, a description is herein given with reference to FIG. 1.

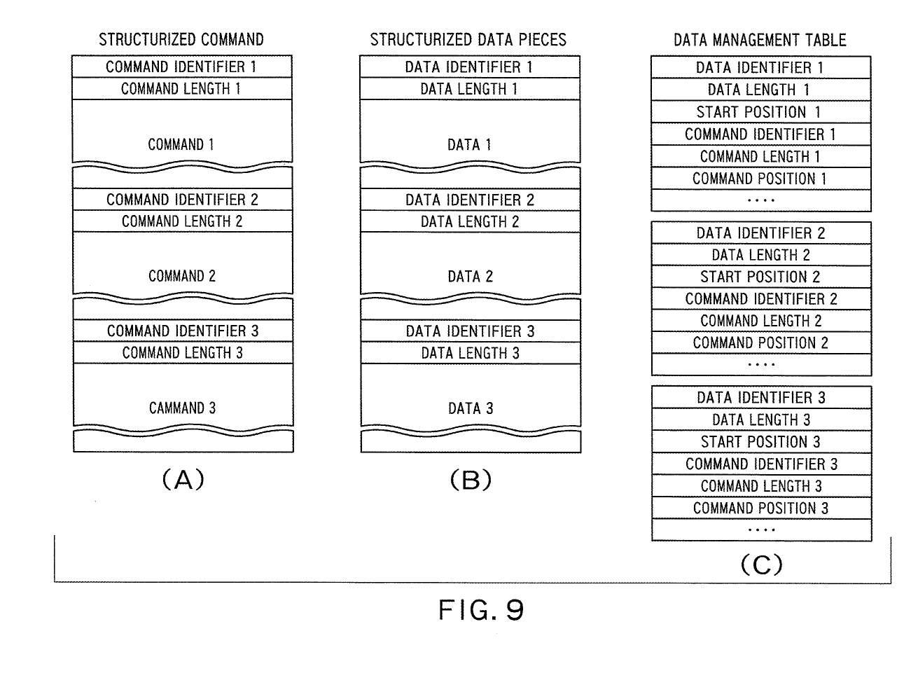

The processor 2 receives an instruction (command) to transmit or receive data from the processor 1, and executes the process thereof. The processor 2 executes the command, and also writes the content of the instruction received from the processor 1 to the data storage 12 as illustrated in FIG. 9(A). Specifically, a command identifier, a command length, and a command itself are grouped as a structurized command, and this structurized command is written. Although sequential write is desirable like the structurized data pieces described in the first embodiment, the write method is not limited thereto. The command identifier is generated by the processor 1 and is sent to the processor 2 together with the command. The information of the write position of the structurized command may be notified to the processor 2 by using a region of the data storage 12 or may directly be notified.

As illustrated in FIG. 9(C), the processor 2 stores the data identifier, the data length, and the data start position described in the first embodiment. In addition, the processor 2 also stores the command identifier, the command length, and the command position in the data storage 12. The command to be written to the data storage includes the entire content of the command, or an URL uniquely linked to the data obtained as a result of executing the command, or a shortened URL. For example, an HTTP request or its header may be stored as a command. A data identifier is derived from the command. An algorithm of derivation is commonly held by the processor 1 and the processor 2.

In the present embodiment, as in the first embodiment, the structurized data pieces illustrated in FIG. 9(B) are written to the data storage 12. When a plurality of structurized data pieces are acquired by prefetching, structurized commands including respective prefetching commands are stored, and structurized data pieces including pre-fetched data pieces are also stored in a similar manner. At the same time, a write access to the data management table is also performed.

When the processor 1 or the processor 2 performs read from the data storage 12, a pair of the command identifier and the data identifier may be identified based on the data management table, and a command and a data piece corresponding to the respective data piece may be read out from the structurized commands and the structurized data pieces for example. Since the data obtained as a result of executing the command can be identified from the content of the command, the processor 2 does not need to manage the commands which are instructed to be executed by the processor 2, nor the names of files which are requested to be acquired by itself. The structurized commands may also be read out from the data storage 1, such as a DRAM, as in the second embodiment. Sequential write may also be performed to write the structurized commands like the structurized data pieces. Although the example of using the data management table to identify a command and the data as its execution result has been described, they may be identified by reading and searching from the heads of the structurized commands and the structurized data pieces, respectively.

The processing apparatus as described above may also be realized using a general-purpose computer device as basic hardware. That is, each block of in the processing apparatus can be realized by causing a processor mounted in the above general-purpose computer device to execute a program. In this case, the processing apparatus may be realized by installing the above described program in the computer device beforehand or may be realized by storing the program in a storage medium such as a CD-ROM or distributing the above described program over a network and installing this program in the computer device as appropriate. Furthermore, the storage may also be realized using a memory device or hard disk incorporated in or externally added to the above described computer device or a storage medium such as CD-R, CD-RW, DVD-RAM, DVD-R as appropriate.

Furthermore, the processing apparatus may include a CPU (Central Processing Unit), a ROM (Read Only Memory) and a RAM as one example of circuitry. In this case, each unit or each element in the processing apparatus can be controlled by a CPU's reading out into a RAM and executing a program which is stored in a storage or ROM.

Also, the above-stated hardware configuration is one example and a part or all of the processing apparatus according to an embodiment can be realized by an integrated circuit such as a LSI (Large Scale Integration) or an IC (Integrated Circuit) chip set as one example of circuitry. Each function block in the processing apparatus can be realized by a processor, individually, or a part or all of the function blocks can be integrated and realized by one processor. A means for the integrating the part or all of the function blocks is not limited to the LSI and may be dedicated circuitry or a general-purpose processor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A processing apparatus, comprising:
a first processor;
a second processor;
a first storage which data read or data write is done by one or more fixed-size blocks, data in each block having a sequential address; and
a controller to control operation of at least one of the first processor and the second processor, wherein
one of the first processor and the second processor writes, to the first storage, first to N-th data pieces in order to deliver the first to N-th data pieces to the other processor so that an ending address of an X-th data piece and a starting address of an X+1-th data piece are sequential addresses wherein “N” being an integer of 2 or more and “X” being an integer of 1 or more and
the controller sets the other processor in a low power consumption mode during at least a part of a period in which the one processor performs writing to the first storage, and after completion of the writing to the first storage, the controller sets the other processor in a different operating mode such as normal operating mode or active operating mode in which the other processor is capable of reading the first to N-th data pieces from the first storage.

2. The processing apparatus according to claim 1, wherein
the one processor writes all the first to N-th data pieces at sequential area in address space in the first storage, respectively.

3. The processing apparatus according to claim 1, further comprising
a communication unit to communicate with another apparatus via a network, wherein
the first processor is the other processor, and the second processor is the one processor,
the first processor requests the second processor to acquire data from said other apparatus,
the controller sets the first processor in the low power consumption mode after the first processor requests data acquisition,
the second processor writes, to the first storage, the first to N-th data pieces that are data pieces acquired from said other apparatus, and
the controller sets the first processor in the normal or active operating mode after completion of writing to the first storage.

4. The processing apparatus according to claim 3, further comprising
a second storage for which data read or data write is done by a size smaller than that of the block, wherein
the controller sets the first processor and the second storage in the low power consumption mode after the first processor requests data acquisition, and sets the first processor and the second storage in the normal or active operating mode after completion of writing of the first to N-th data pieces to the first storage, and
after the second storage is set in the normal or active operating mode, one of the first processor and the second processor reads out the first to N-th data pieces written to the first storage and writes the read data pieces to the second storage.

5. The processing apparatus according to claim 1, further comprising
a communication unit to communicate with another apparatus via a network, wherein
the first processor is the one processor, and the second processor is the other processor,
the first processor writes, to the first storage, the first to N-th data pieces that are data pieces to be transmitted to said other apparatus,
after completion of writing of the first to N-th data pieces to the first storage, the controller sets the second processor in the normal or active operating mode and sets the first processor in the low power consumption mode, and
the second processor reads out the first to N-th data pieces from the first storage, and transmits the read data pieces to said other apparatus by using the communication unit.

6. The processing apparatus according to claim 1, wherein
the one processor writes, to the first storage, first to N-th structurized data pieces so that an ending address of an X-th structurized data piece and a starting address of an X+1-th structurized data piece are sequential, the first to N-th structurized data pieces including management information attached to each head of the first to N-th data pieces, the management information including a data identifier identifying each of the first to N-th data pieces and length information of each of the first to N-th data pieces.

7. The processing apparatus according to claim 6, wherein
the one processor writes all the first to N-th structurized data pieces at sequential area in address space in the first storage, respectively.

8. The processing apparatus according to claim 6, wherein
the other processor starts reading from the starting address of the first structurized data piece, and identifies and reads out the first to N-th data pieces based on the data identifier and the length information included in each structurized data piece.

9. The processing apparatus according to claim 6, wherein
the one processor generates a data management table including, at least the data identifier, the data starting address, and the data length information for each of the first to N-th data pieces, and writes the data management table to the first storage.

10. The processing apparatus according to claim 6, wherein
the other processor reads out the first to N-th data pieces from the first storage based on the data management table.

11. The processing apparatus according to claim 6, wherein
the first processor issues to the second processor a request to execute a command that instructs data reception or data transmission,
the one processor writes a structurized command, to the first storage, the structurized command including management information and either one of the command or an abbreviation of the command, the management information including an identifier of the command and a length of the command and
a data identifier of data received or transmitted by execution of the command is obtained based on either one of the command or the abbreviation of the command.

12. The processing apparatus according to claim 6, wherein
the one processor generates a data management table including, for each of the data pieces, at least the data identifier of the data piece, the starting address of the data piece, the length information of the data piece, the identifier of a command which instructs data reception or data transmission, a starting address of the command, and length information of the command, and writes the data management table to the first storage.

13. The processing apparatus according to claim 1, wherein
the first storage is a NAND flash memory.

14. The processing apparatus according to claim 6, further comprising
a second storage from which data read or data write is done by a size smaller than that of the block, wherein
the first processor writes the first to N-th structurized data pieces or the first to N-th data pieces to the second storage, and generates a list including addresses of the second storage to which the first to N-th structurized data pieces or the first to N-th data pieces were written.

15. The processing apparatus according to claim 4, wherein
the second storage is a memory readable and writable in units of bytes.

16. A processing method, comprising:
writing by one of the first processor and the second processor, to the first storage, first to N-th data pieces in order to deliver the first to N-th data pieces to the other processor wherein the first storage is a storage for which data read or data write is done by one or more fixed-size blocks, data in each block having a sequential address, and the writing is carried out so that an ending address of an X-th data piece and a starting address of an X+1-th data piece are sequential addresses wherein “N” being an integer of 2 or more and “X” being an integer of 1 or more and
setting the other processor in a low power consumption mode during at least a part of a period in which the one processor performs writing to the first storage, and after completion of the writing to the first storage, setting the other processor in a normal or active operating mode in which the other processor is capable of reading the first to N-th data pieces from the first storage.
